(19) United States
(12) Patent Application Publication
(10) Pub. No.: US 2006/0253277 A1
(43) Pub. Date: Nov. 9, 2006

(54) Device and method for paramertizable controlling

(76) Inventor: Klaus Behringer, Igensdorf (DE)

Correspondence Address: HARNESS, DICKEY & PIERCE, P.L.C., P.O.BOX 8910, RESTON, VA, 20195, US

(21) Appl. No.: 10/562,705

(22) PCT Filed: Jun. 17, 2004
(86) PCT No.: PCT/EP04/06532

§ 371 Date: Dec. 29, 2005

(30) Foreign Application Priority Data
Jun. 30, 2003 (EP) 03014878.7

(51) Int. Cl. G10L 19/02

(52) U.S. Cl. 704/203

(57) ABSTRACT

To increase parameterization of control devices which include several inputs and several outputs, all combinations of inputs do not have to be evaluated for determining an output value. The set point value of input states are set to an independent state value such that only those real values and set point values have to be compared in a comparative step. The set point value does not match the independent state value, allowing the runtime for determining the output state values to be reduced.

This application is the national phase under 35 U.S.C. §371 of PCT International Application No. PCT/EP2004/006532 which has an International filing date of Jun. 17, 2004, which designated the United States of America and which claims priority on German Patent Application number 03014878.7 filed Jun. 30, 2003, the entire contents of which are hereby incorporated herein by reference.

### FIELD

The present invention generally relates to a control device. For example, it may relate to one having a plurality of inputs for respectively receiving an input real value, a plurality of outputs for respectively outputting a digital output value, a memory for storing setpoint values relating to the inputs and outputs, and an allocator for allocating a digital output value to one of the digital outputs as a function of a comparison of at least one of the input real values with a corresponding setpoint value. The present invention also generally relates to a corresponding method for controlling equipment.

### BACKGROUND

In many applications of control technology, outputs Yⱼ are switched on or off as a function of inputs Xᵢ. A control device is in this case characterized by the number of outputs jₘₐₓ and the number of inputs iₘₐₓ. With respectively two inputs and outputs, i.e. jₘₐₓ=2 and iₘₐₓ=2, sixteen different states are in principle conceivable. Correspondingly for controllers with eighteen input and outputs, which are widely used in control technology, more than 260,000 different states are already possible.

In equipment produced to date, all the inputs and outputs are evaluated by programmed technology. This, however, presents the following disadvantages with an increasing number of inputs and outputs (IOs): There is a great need for ROM and RAM. Furthermore, the parameterization table which increases exponentially in size requires a very large EEPROM, long reading times etc. The large number of states furthermore requires very complex parameterization and entails very long runtimes. Especially for safety technology, the latter is a great problem as regards emergency stop reaction times and maximum test times for the second fault occurrence time.

A controller of this high complexity is known, for example, from Pilz under the reference “PNOZ MULTI”. A large part of the logic is in this case embodied in hardware. This is correspondingly configured extensively owing to redundancy and diversity, associated with an SFF level of more than 90% for the KAT4 safety standard. Two different controller types are in this case used with different firmware. The purpose of this is that the faster controller carries out the control functions and the slower controller is used for the monitoring.

U.S. Pat. No. 4,510,602 discloses a programmable logic device which includes a multiplicity of memory devices, instruction words and masking words being stored in each of these memory devices, the words respectively including a multiplicity of bits. By way of a comparator unit and a comparer unit, a comparison of a word found on a data bus is carried out with an instruction word contained in a memory and a masking word. The data bus is in this case connected to inputs and outputs of the device. Depending on a comparison carried out, a marker unit which transfers a marker signal to outputs of the device is activated by the comparator unit. The individual bits of the instruction words and the masking words can take the digital states “1” and “0”.

U.S. Pat. No. 5,623,680 discloses a state machine, which includes a memory in which logic specifications are stored. The changes of the outputs are determined by these logic specifications as a function of predetermined combinations of input parameters, and a change of states is carried out as a function of stored logic states of the input parameters. The state specifications are in this case formed by separate 8-bit words and combined with an input vector by a logical AND operation. The input vectors are in this case undescribed and characterize that by that only a single state which is specified by a further vector can determine a state transition.

For their part, the present Applicant sells safety equipment of the Siguard series on the market, which makes do with one firmware and one controller type, although master-slave operation is necessary in which both controllers execute all the control functions and therefore in principle require double the runtime compared with the aforementioned equipment. This is therefore compensated for by a high-performance algorithm.

### SUMMARY

It is an object of at least one embodiment of the present invention to provide a less elaborate controller and a corresponding method for safety technology.

According to at least one embodiment of the invention, an object may be achieved by a control device having a plurality of inputs for respectively receiving an input real value, a plurality of outputs for respectively outputting a digital output value, a memory for storing setpoint values relating to the inputs and outputs, and an allocator for allocating a digital output value to one of the digital outputs as a function of a comparison of at least one of the input real values with a corresponding setpoint value. An independence state value can be applied to at least one of the setpoint values in the memory. Further, the allocation of a digital output value to one of the digital outputs can be carried out by the allocator independently of the at least one input real value whose allocated setpoint value has the independence state value. The setpoint values respectively have one of the state values 1, 0 and independence state value. In this way, for example, it is possible to produce the binary states “TRUE” and “FALSE” as well as a state which is insignificant for the output result.

At least one embodiment of the invention also relates to a method for controlling equipment by receiving a plurality of input real values, providing setpoint values relating to input and outputs, establishing a digital output value as a function of a comparison of at least one of the input real values with a corresponding one of the setpoint values, outputting the digital output value, applying an independence state value to at least one of the setpoint values, and establishing the digital output value independently of the at least one input real value whose allocated setpoint value has the independence state value. The setpoint values respectively have one of the state values 1, 0 and independence state value. In this way, for example, it is possible to produce the binary states “TRUE” and “FALSE” as well as a state which is insignificant for the output result.

In safety technology, the error susceptibility and verifiability of the algorithm are of prime importance. If the computing outlay is reduced according to at least one embodiment of the invention, a reliable control function can therefore be readily achieved in master-slave operation.

The control device according to at least one embodiment of the invention may include a first evaluator for converting input raw values into digital input values for the further processing as input real values. This makes it possible, for example, to classify analog input signals as an active or inactive input.

A second evaluator may furthermore be provided in the control device, which is connected downstream of the first evaluator. This allows the digital input values to be allocated to logical input states for the further processing as input real values.

Preferably, the setpoint values respectively have one of the state values 1, 0 and independence state value. In this way, for example, it is possible to produce the binary states “TRUE” and “FALSE” as well as a state which is insignificant for the output result.

A plurality of sets of setpoint values may be stored, for example, respectively for an output value or set of output values in the memory. In this way, a plurality of parameterizations can be stored simultaneously in the equipment.

The control device according to at least one embodiment of the invention may have a safety instrument by which the equipment to be controlled can be switched to a safety state. For example, it may be switched to the safety state if the output real values deviate from the corresponding setpoint values for more than a predetermined time. In a special example of this, the control device may include two controllers which both execute the algorithm and store all fulfilled parameterizations as well as the output vector Yⱼ in binary form. These stored values are compared in each cycle. If they deviate for a time which is longer than a predetermined maximum time, then the equipment to be controlled is switched to a safe state.

The safety device may be optimized by checking the sets of setpoint values with a check sum at fixed time intervals. In particular, a setpoint value matrix i.e. a fixed parameterization, which is stored in the memory, may be secured by a cyclic CRC (cyclic redundancy check sum) and verified at fixed time intervals in order to discover errors in the matrix S or in the memory. In this way, a variable function can be checked for errors straightforwardly.

### BRIEF DESCRIPTION OF THE DRAWINGS

Embodiments of the present invention will now be explained in more detail with the aid of the appended drawings, in which:

FIG. 1 shows an outline flow chart of the preprocessing of the input real values; and

FIG. 2 shows a logic diagram for the allocation of output states according to at least one embodiment of the invention.

### DETAILED DESCRIPTION OF THE EXAMPLE EMBODIMENTS

The example embodiments described in detail below represent preferred embodiments of the present invention.

The outputs Y of the control-safety equipment are the result of a switching function H with input X:
Y=H(X)

The input X, or the plurality of inputs Xᵢ, in this case may respectively have the following states independently of its/their function:

$${X}_{i} = \begin{matrix}0 ( “ FALSE ” ) & input must be inactive \\ 1 ( “ TRUE ” ) & input must be active \\ D ( “ DONTCARE ” ) & input state may be anything\end{matrix}$$

In control technology, an active output state Yⱼ is generally reached for precisely one or very few input state vectors. For most of the input state vectors Xᵢ, the output or outputs are inactively configured. With uncorrelated inputs, i.e. inputs that do not affect one another, for example operating selector switch, muting, key switch or the like, there are usually at most jₘₐₓ input state vectors for jₘₐₓ active outputs Yⱼ.

If the inputs are correlated, however, then:

Number of the active output states

$${Y}_{j} < {{\sum }_{1}}^{{j}_{max}} ( \prod {Z}_{i} )$$

Here, Zᵢ corresponds to the number of correlations of the inputs Xᵢ. In the limiting case of uncorrelated inputs, Z=1 since the inputs are then only correlated with themselves.

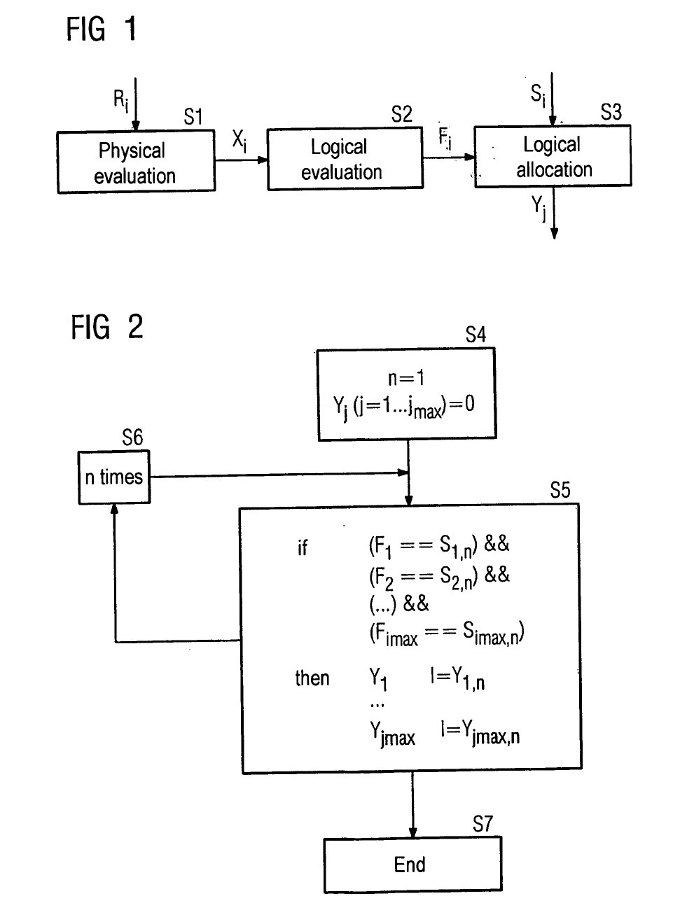

The evaluation of the inputs is carried out in two stages according to this example according to at least one embodiment of the invention, as indicated in FIG. 1. Raw input data Rᵢ, for example analog signals or digital signals of any level, are first subjected to a physical evaluation. Here, for example, the allocation Xᵢ=1 is made when the corresponding input is active, and Xᵢ=0 when the input is inactive.

In a second step S2, the digital input values Xᵢ are logically evaluated. Each input therefore has a function ID, for example ID₁=ID_POWERBUTTON. A logical input state or function value Fᵢ is assigned to each digital input value Xᵢ. In the example, Fᵢ=1 would apply if the power button has been actuated successfully, and Fᵢ=0 would apply if the power button has not been actuated or has not been actuated successfully.

A logical allocation is carried out in the further step S3, each real value Fᵢ being compared with a setpoint value Sᵢ. A corresponding output value Yⱼ results from this comparison. Preferably, the controller is configured so that nₘₐₓ different parameterizations can be stored in it. Thus, for all the nₘₐₓ parameterizations, a set of setpoint values S_{i,n} is respectively stored. They have the values

| | | |
|---|---|---|
| S_{i, n} | 0 (“FALSE”) | input must be inactive |
| | 1 (“TRUE”) | input must be active |
| | D (“DONTCARE”) | input state may be anything |

FIG. 2 shows a flow chart for determining the output states Yⱼ. In an initialization step S4, the number of the parameter set is put at n=1 and the output value Yⱼ is put at zero. In a further step S5, the logical input states Fᵢ for each parameterization n are compared with the allocated threshold value S_{i,n} (comparison operator “==”). All the comparisons are combined by the AND operator “&&”. If the overall result of the comparisons is “TRUE”, then the respective output Yⱼ receives the value of the logic operation “Yⱼ OR Y_{j,n}”. In this case, Y_{j,n} corresponds to the value stored as a setpoint value together with S_{i,n}.

The comparison routine of step S5 is repeated n times according to step S6. After this, the output value assignment is ended according to step S7.

For each parameterization, the output Yⱼ with Y_{j,n}=1 may then be connected up or activated. Otherwise, the respective output Yⱼ is inactive.

According to at least one embodiment of the invention, not every real value Fᵢ is compared with the corresponding setpoint value S_{i,n} in step S5. Rather, a comparison is only carried out if the setpoint value S_{i,n} does not have the value “D”. This can avoid a multiplicity of comparison operations. The total runtime for determining the output states is correspondingly reduced.

If the inputs are mutually independent, for example in the case of parallel switches, then the number of parameterizations nₘₐₓ is equal to the total number of outputs jₘₐₓ. If the inputs are dependent on one another, however, for example switches connected in series, then two parameterizations may for example be necessary for one output.

In a specific example, eleven independent inputs are applied to the controller in order to control four outputs. Accordingly, four different parameterizations must be stored in the controller.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A control device, comprising:
a plurality of inputs to respectively receive an input real value;
a plurality of outputs to respectively output a digital output value;
a memory to store setpoint values relating to the inputs and outputs; and
an allocator to allocate a digital output value to one of the digital outputs as a function of a comparison of at least one of the input real values with a corresponding setpoint value,
the setpoint values respectively including one of the state values 1, 0 and independence state value, applicable to at least one of the setpoint values in the memory, and
the allocation of a digital output value to one of the digital outputs being capable of being carried out by the allocator independently of the at least one input real value whose allocated setpoint value includes the independence state value.

2. The control device as claimed in claim 1, further comprising a first evaluator for converting input raw values into digital input values for the further processing as input real values.

3. The control device as claimed in claim 2, further comprising a second evaluator, connected downstream of the first, for allocating the digital input values to logical input states for the further processing as input real values.

4. The control device as claimed in claim 1, wherein a plurality of sets of setpoint values are respectively being storable for an output value or set of output values in the memory.

5. The control device as claimed in claim 1, further comprising a safety instrument by which the equipment to be controlled can be switched to a safety state.

6. The control device as claimed in claim 5, wherein the safety instrument switches to the safety state if the input real values deviate from the corresponding setpoint values for more than a predetermined time.

7. The control device as claimed in claim 5, wherein the sets of setpoint values are checked with a check sum at fixed time intervals.

8. A method for controlling equipment, comprising:
receiving a plurality of input real values;
providing setpoint values relating to inputs and outputs;
establishing a digital output value as a function of a comparison of at least one of the input real values with a corresponding one of the setpoint values; and
outputting the digital output value,
an independence state value being applied to at least one of the setpoint values,
the digital output value being established independently of the at least one input real value whose allocated setpoint value includes the independence state value, wherein
the setpoint values respectively include one of the state values 1, 0 and independence state value.

9. The method as claimed in claim 8, wherein the reception of a plurality of input real values includes conversion of input raw values into digital input values for the further processing as input real values.

10. The method as claimed in claim 9, wherein the digital input values are allocated to logical input states for the further processing.

11. The method as claimed in claim 8, wherein a plurality of sets of setpoint values are respectively provided for an output value or set of output values.

12. The method as claimed in claim 8, wherein the equipment to be controlled is switched to the safety state if the input real values deviate from the corresponding setpoint values for more than a predetermined time.

13. The method as claimed in claim 8, wherein the setpoint values are checked with a check sum at fixed time intervals, and the equipment to be controlled is optionally switched to a safety state.

14. (canceled)

15. (canceled)

16. The control device as claimed in claim 2, wherein a plurality of sets of setpoint values are respectively being storable for an output value or set of output values in the memory.

17. The control device as claimed in claim 3, wherein a plurality of sets of setpoint values are respectively being storable for an output value or set of output values in the memory.

18. The control device as claimed in claim 6, wherein the sets of setpoint values are checked with a check sum at fixed time intervals.

19. The method as claimed in claims 9, wherein a plurality of sets of setpoint values are respectively provided for an output value or set of output values.

20. The method as claimed in claims 10, wherein a plurality of sets of setpoint values are respectively provided for an output value or set of output values.

21. A control device, comprising:
input means for respectively receiving an input real value;
output means for respectively outputting a digital output value;
memory means for storing setpoint values relating to the inputs and outputs; and
allocation means for allocating a digital output value to one of the digital outputs as a function of a comparison of at least one of the input real values with a corresponding setpoint value, the setpoint values respectively including one of the state values 1, 0 and independence state value, applicable to at least one of the setpoint values in the memory means, and the allocation of a digital output value to one of the digital outputs being capable of being carried out by the allocation means independently of the at least one input real value whose allocated setpoint value includes the independence state value.
